(19) United States
(12) Patent Application Publication
(10) Pub. No.: US 2020/0293136 A1
(43) Pub. Date: Sep. 17, 2020

(54) TOUCH SENSITIVE APPARATUS

(71) Applicant: FlatFrog Laboratories AB, Lund (SE)

(72) Inventors: Kristofer JAKOBSON, Malmö (SE); Tomas CHRISTIANSSON, Torna Hällestad (SE); Pablo CASES, Lomma (SE); Linnea LARSSON, Lund (SE)

(21) Appl. No.: 16/645,383

(22) PCT Filed: Sep. 6, 2018
(86) PCT No.: PCT/SE2018/050896

§ 371 Date: Mar. 6, 2020

(30) Foreign Application Priority Data
Sep. 8, 2017 (SE) 1730242-3

(51) Int. Cl. G06F 3/041; G06F 3/044; G06F 3/042

(52) U.S. Cl. CPC G06F 3/0412; G06F 3/0425; G06F 3/044

(57) ABSTRACT

A touch sensitive apparatus is disclosed comprising a touch surface configured to receive touch input, a touch sensor configured to determine a surface coordinate of a touch input on the touch surface, an imaging device configured to capture image data of a user input device adapted to engage the touch surface to provide said touch input, a processing unit configured to receive a first surface coordinate of a touch input from the touch sensor; and correlate a touch input at a first surface coordinate with a first image sensor coordinate at which image data of the input device is captured; and generate a touch output signal based on the captured image data of the input device at the first image sensor coordinate. The touch output signal comprises a value for controlling user input device interaction associated with the touch input at the first surface coordinate.

### TECHNICAL FIELD

The present invention relates generally to the field of touch-based interaction systems. More particularly, the present invention relates to techniques for uniquely identifying objects to be used on a touch surface of a touch sensitive apparatus and a related method.

### BACKGROUND

In various touch based systems, it is desirable to distinguish between different touch input in order to control the interaction with the particular touch application. Such control is desirable both in terms of varying the display of the touch operations on the screen, such as writing or drawing with different colors, brushes or patterns, and also for controlling different operations in the touch application, depending on the particular user input device used. In some applications it is also desirable to distinguish between different users based on what input device is used. Some user input devices utilize active identification components and methods for associating different interaction characteristics with a particular user input device. Previous techniques for distinguishing user input devices are often associated with complex identification techniques, with high demands on the accuracy or resolution of the involved signal- or image processing techniques. This may accordingly hinder the development towards more feasible but highly customizable and intuitive touch systems.

Hence, an improved touch sensitive apparatus, system and method for distinguishing user input devices would be advantageous.

### SUMMARY

It is an objective of the invention to at least partly overcome one or more of the above-identified limitations of the prior art.

One objective is to provide a touch sensitive apparatus and system in which identification of different user input devices is facilitated.

Another objective is to provide a touch sensitive apparatus and system in which identification of different passive user input devices is facilitated.

One or more of these objectives, and other objectives that may appear from the description below, are at least partly achieved by means of a touch sensitive apparatus, system and a related method according to the independent claims, embodiments thereof being defined by the dependent claims.

According to a first aspect a touch sensitive apparatus is provided comprising a touch surface configured to receive touch input, a touch sensor configured to determine a surface coordinate (x, y) of a touch input on the touch surface, an imaging device having a field of view looking generally along the touch surface, whereby the imaging device is configured to capture image data of a user input device adapted to engage the touch surface to provide said touch input. The touch sensitive apparatus comprises a processing unit configured to receive a first surface coordinate of a touch input from the touch sensor; and correlate a touch input at a first surface coordinate with a first image sensor coordinate at which image data of the input device is captured by the imaging device; and

generate a touch output signal based on the captured image data of the input device at the first image sensor coordinate, wherein the touch output signal comprises a value for controlling user input device interaction associated with the touch input at the first surface coordinate.

According to a second aspect a touch system is provided comprising a touch sensitive apparatus according to the first aspect and a user input device, wherein the user input device comprises a marker having a predefined color parameter such as a predefined color balance.

According to a third aspect a method in a touch sensitive apparatus having a touch surface configured to receive touch input is provided. The method comprises capturing image data of a user input device adapted to engage the touch surface to provide said touch input, determining a surface coordinate of a touch input on the touch surface, correlating a touch input at a first surface coordinate with a first image sensor coordinate at which image data of the input device is captured by the imaging device, and generating a touch output signal based on the captured image data of the input device at the first image sensor coordinate, wherein the touch output signal comprises a value for controlling user input device interaction associated with the touch input at the first surface coordinate.

According to a fourth aspect a computer program product is provided comprising instructions which, when the program is executed by a computer, cause the computer to carry out the steps of the method according to the third aspect.

According to a fifth aspect a touch input identification device is provided for a touch sensitive apparatus having a touch surface configured to receive touch input. The touch input identification device comprises an imaging device configured to be arranged on the touch sensitive apparatus to have field of view looking generally along the touch surface, whereby the imaging device is configured to capture image data of a user input device adapted to engage the touch surface to provide said touch input, a processing unit configured to retrieve a surface coordinate of a touch input on the touch surface, correlate a touch input at a first surface coordinate with a first image sensor coordinate at which image data of the input device is captured by the imaging device, and generate a touch output signal based on the captured image data of the input device at the first image sensor coordinate, wherein the touch output signal comprises a value for controlling user input device interaction associated with the touch input at the first surface coordinate.

Further examples of the invention are defined in the dependent claims, wherein features for the second and subsequent aspects of the disclosure are as for the first aspect mutatis mutandis.

Some examples of the disclosure provide for facilitating identification of user input devices in a touch-based system.

Some examples of the disclosure provide for distinguishing an increased number of different user input devices in a touch-based system.

Some examples of the disclosure provide for facilitated differentiation of a plurality of passive user input devices in a touch-based system.

Some examples of the disclosure provide for a more intuitive identification of different user input devices.

Some examples of the disclosure provide for a less complex and/or costly identification of different user input devices in a touch-based system.

Some examples of the disclosure provide for providing less complex user input device identification while maintaining high-accuracy touch input.

Some examples of the disclosure provide for facilitated color identification in a touch-based system.

Some examples of the disclosure provide for a more reliable and robust input device identification.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which examples of the invention are capable of will be apparent and elucidated from the following description of examples of the present invention, reference being made to the accompanying schematic drawings, in which;

FIGS. 1a-b show a touch sensitive apparatus and a touch system, in a schematic top-down view, according to examples of the disclosure;

FIG. 2a shows a touch sensitive apparatus, a touch system, and an image sensor coordinate system, according to an example of the disclosure;

FIG. 2b shows an image sensor coordinate system, according to an example of the disclosure;

FIG. 3 shows an image sensor coordinate system, according to an example of the disclosure;

FIG. 4 shows a touch sensitive apparatus and a touch system, in a schematic top-down view, according to an example of the disclosure;

FIGS. 5a-b show a touch sensitive apparatus and a touch system, in schematic side views, according to an example of the disclosure;

FIG. 6 shows a user input device, according to an example of the disclosure;

FIG. 7a is a flowchart of a method in a touch sensitive apparatus; and

FIG. 7b is a further flowchart of a method in a touch sensitive apparatus according to examples of the disclosure.

### DETAILED DESCRIPTION

Specific examples of the invention will now be described with reference to the accompanying drawings. This invention may, however, be embodied in many different forms and should not be construed as limited to the examples set forth herein; rather, these examples are provided so that this disclosure will be thorough and complete, and will fully convey the scope of the invention to those skilled in the art. The terminology used in the detailed description of the examples illustrated in the accompanying drawings is not intended to be limiting of the invention. In the drawings, like numbers refer to like elements.

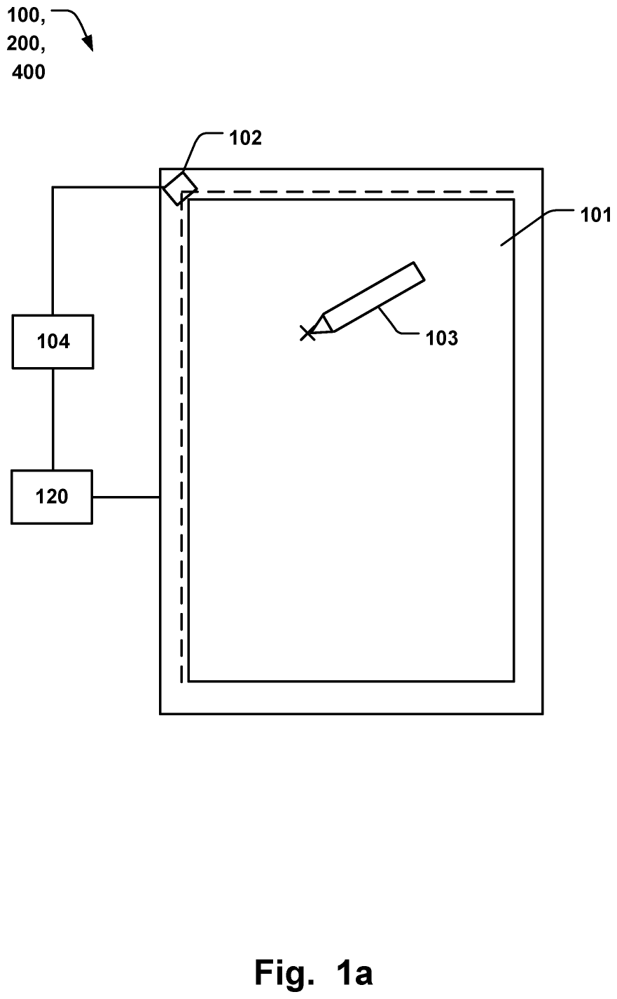

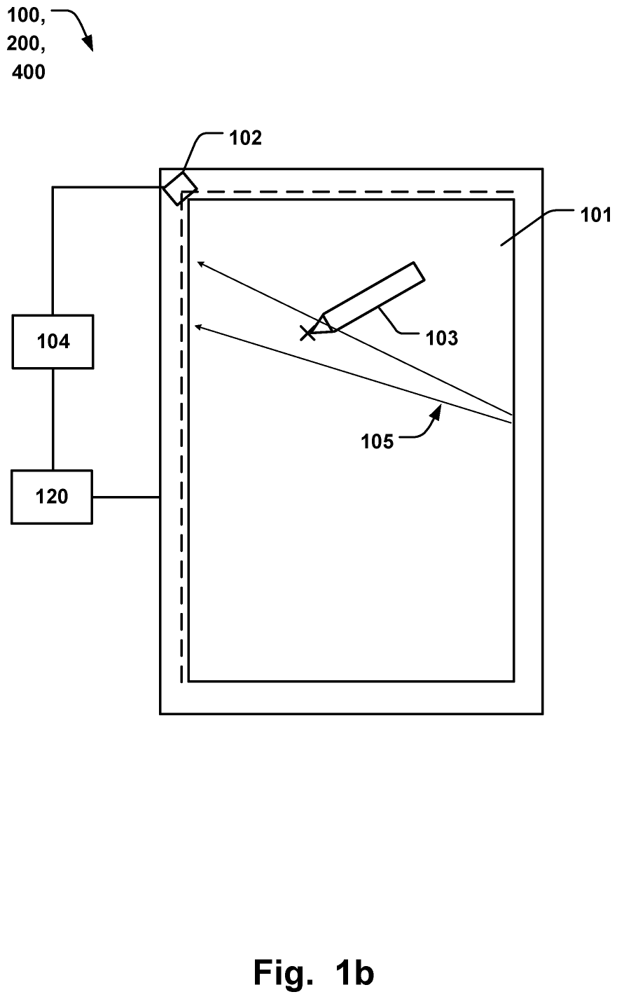

FIG. 1a is a schematic illustration of a touch sensitive apparatus 100 comprising a touch surface 101 configured to receive touch input, and a touch sensor 120 configured to determine a surface coordinate (x, y) of a touch input on the touch surface 101. The touch sensitive apparatus 100 comprises an imaging device 102 having a field of view looking generally along the touch surface 101. The field of view advantageously covers the entire touch surface 101, and/or the imaging device 102 is advantageously arranged so that imaging data of a user input device 103 can be captured for all positions thereof, when engaged with the touch surface 101, or when in a position adjacent the touch surface 101, about to engage the touch surface 101. The imaging device 102 is thus configured to capture image data of a user input device 103 being adapted to engage the touch surface 101 to provide touch input. The user input device 103 may be a stylus. The touch sensitive apparatus 100 comprises a processing unit 104 configured to receive a first surface coordinate (x′, y′) of a touch input from the touch sensor 120. The touch sensor 120 may detect the surface coordinates of touch input based on different techniques. E.g. the touch sensor 120 may comprise capacitive sensor, such as for a projected touch screen, or an optical sensor. In the latter case, the processing unit 104 may be configured to determine a surface coordinate (x, y) of a touch input, provided by e.g. a stylus, on the touch surface 101 from a position of an attenuation of light beams 105 emitted along the touch surface 101, as schematically illustrated in FIG. 1b. A plurality of optical emitters and optical receivers may be arranged around the periphery of the touch surface 101 to create a grid of intersecting light paths (otherwise known as detection lines). Each light path extends between a respective emitter/receiver pair. An object that touches the touch surface will block or attenuate some of the light paths. Based on the identity of the receivers detecting a blocked light path, the location of the intercept between the blocked light paths can be determined. The position of touch input can thus be determined with high accuracy.

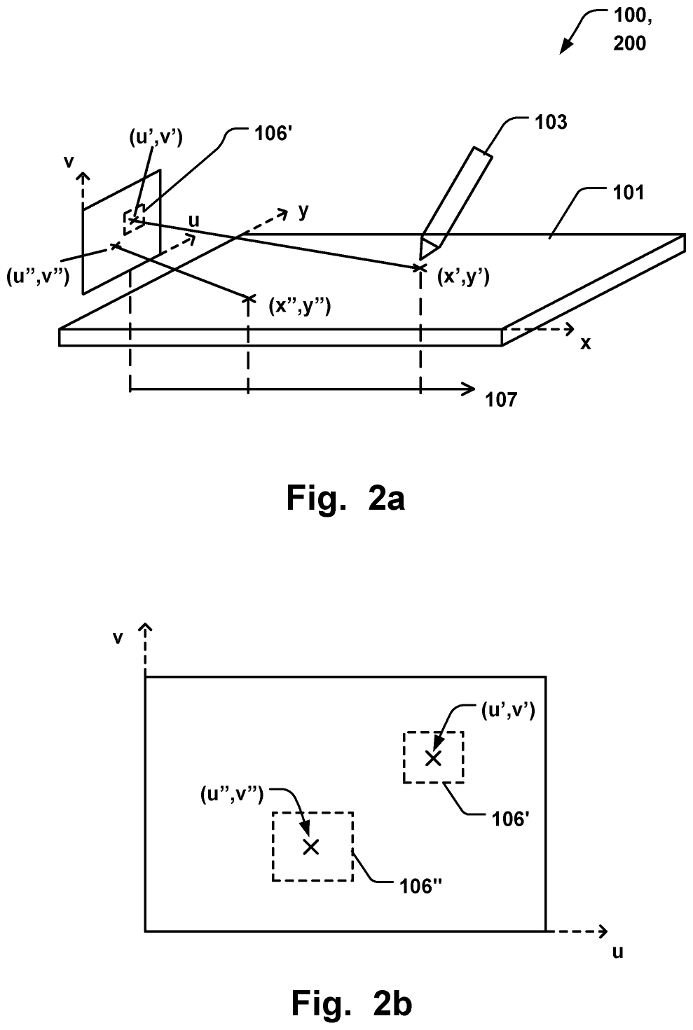

The processing unit 104 is further configured to correlate the touch input at the first surface coordinate (x′, y′) with a first image sensor coordinate (u′, v′) at which image data of the input device 103 is captured by the imaging device 102. FIG. 2a shows a schematic illustration of the touch surface 101 and the related surface coordinate system (x, y), as well as the image sensor coordinate system (u, v) of the imaging device 102. Touch input with the user input device 103 on the touch surface 101 generates a corresponding surface coordinate (x, y) for the touch input, as described above. The surface coordinate (x, y) is connected with an image sensor coordinate (u, v) of the imaging device 102 which comprises image data of the user input device 103.

The processing unit 104 is configured to generate a touch output signal based on the captured image data of the input device 103 at the first image sensor coordinate (u′, v′). The touch output signal comprises a value or variable for controlling user input device interaction associated with the touch input at the first surface coordinate (x′, y′). The user input device 103 may for example interact with various touch applications, in control by or in other ways communicating with the touch sensitive apparatus 100. The captured image data may thus be utilized to control the interaction or a response in such touch application from the touch input. For example, the captured image data may be utilized to control characteristics of a visual output, such varying the color or style of drawing brushes, by correlating the touch input with the image sensor coordinate (u′, v′) containing said image data, while the positioning of the user input device 103 can be processed independently from the imaging device 102 and the captured image data. High-resolution positioning, as described above in relation to determining the surface coordinate (x, y), may thus be combined with a readily implementable output control based on image data that can be obtained from lower-resolution imaging devices 102, since the output characteristics can be determined from the appearance of the particular user input device 103 (typically occupying a region in the captured image, as described further below) in the image sensor coordinate system (u, v), at its correlated position. This provides also for utilizing a single imaging device 102, since triangulation etc. can be dispensed with, to realize a less complex touch identification system 100. The appearance of the input device 103 in the captured image data may be altered by e.g. changing the color of the input device 103, which provides for an advantageous identification by the imaging device 102, since is not necessary to resolve e.g. different patterns on the input device 103 or different shapes of the input device 103. This further contributes to allowing robust identification of a plurality of different user input devices 103 with less complex imaging device systems. Having a set of input devices 103 each generating a different appearance in the image data, e.g. by being differently colored, thus provides for associating captured image data of a particular input device 103 with a unique input characteristic in the touch sensitive apparatus 100, and further, an associated visual output having a corresponding color as the particular input device 103.

As mentioned, the touch output signal comprises a value for controlling the interaction or response associated with the touch input at the first surface coordinate (x′, y′), such as interaction between the user input device 103 and a touch application. The value may comprise a set of control values or variables or instructions configured to control the interaction or response associated with the touch input at the first surface coordinate (x′, y′). The value may be configured to control visual output associated with touch input at the first surface coordinate (x′, y′), so that the visual output is based on the captured image data of the input device 103 at the first image sensor coordinate (u′, v′). The visual output may comprise a digital ink, applied by the user input device 103, and the value may be configured to control the characteristics of the digital ink, e.g. varying the color or style of drawing brushes. The imaging device 102 may be configured to capture image data comprising color information of the user input device 103, and the processing unit 104 may be configured to generate a touch output signal comprising a value configured to control color of the visual output based on said color information, as elucidated in the example given above. The visual output may be displayed by a display panel (not shown) at the position of the surface coordinate (x, y) of the current touch input. I.e. the touch sensitive apparatus 100 and the touch surface 101 thereof may be arranged over a display panel, so that the surface coordinates (x, y) of the touch surface 101 are aligned with corresponding pixels of the display panel. It is conceivable however that visual output may be displayed at a related position, e.g. with an off-set distance from the surface coordinate (x, y) at which the input device 103 is in engagement with the touch surface 101. The processing unit 104 may thus be configured to control a display panel for generation of visual output at the first surface coordinate (x′, y′), or at a position associated with first surface coordinate (x′, y′), based on the captured image data of the input device 103 at the first image sensor coordinate (u′, v′). It is also conceivable that the visual output is shown on a display panel which is not aligned with the touch surface 101 receiving the touch input, e.g. if having the touch surface 101 configured as a personal sketch pad for contributing to visual output provided by a detached display panel in a conference environment.

Although the examples above primarily discuss the benefits of generating visual output based on the captured image data of the user input device 103 it is also conceivable that the image data is utilized to control other aspects of the interaction provided by the user input device 103. E.g. touch applications and GUI objects may be customized depending on the image data captured of the particular user input device 103. For example, differently colored styluses may be uniquely associated with GUI objects of corresponding colors. Complex multi-layer drawings, e.g. in a CAD environment, could then be manipulated at a particular colored layer at a time, by allowing e.g. only manipulation with a correspondingly colored stylus.

The image data may be utilized to control other aspects of the interaction provided by the user input device 103. For example, the touch output signal may comprise a value used to control interaction associated with the touch input such as acoustic response to the touch input. I.e. the captured image data of a particular user input device 103 may be uniquely associated with particular acoustic response for the user, e.g. in touch applications utilizing sound as an aid for the user interaction, or for simulation of musical instruments.

It is further conceivable that the generated touch output signal, based on the captured image data as explained above, is utilized in various peripheral systems configured to communicate with the touch sensitive apparatus 100. The touch output signal may for example be retrieved with the purpose of subsequent analysis and/or communication over a system or network, or storing, e.g. in touch applications configured for authentication processes, or whenever it is desired to customize or distinguish user interaction amongst sets of user input devices 103, possibly interacting with different touch sensitive apparatuses 100.

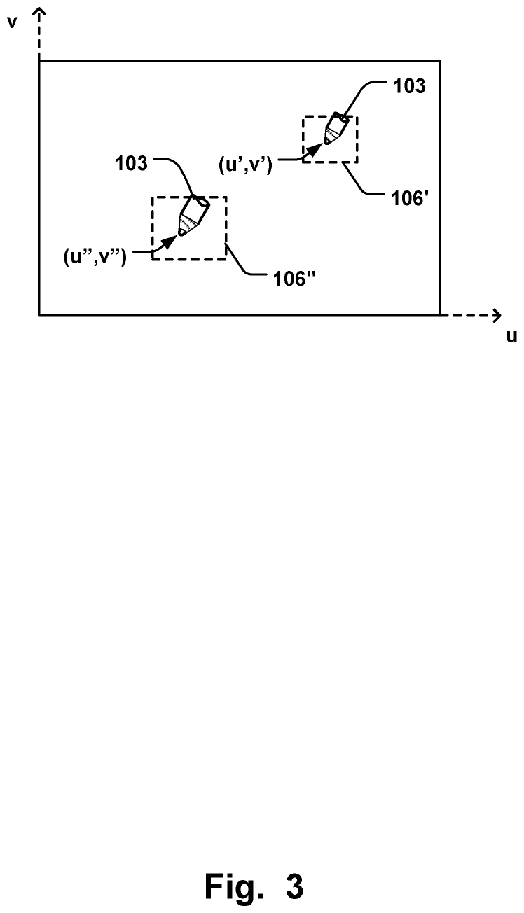

The processing unit 104 may be configured to determine an image target region 106′, 106″, in the image sensor coordinate system (u, v) of the imaging device 102, in which image data of the user input device 103 is captured. FIG. 3 schematically illustrates a first image target region 106′, in which image data of a user input device 103 is captured. FIG. 3 also illustrates a second image target region 106″ which will be referred to below. The first image target region 106′ has captured image data originating from both the background and the user input device 103. The processing unit 104 may be configured to determine a position of the first image sensor coordinate (u′, v′) in the image target region 106′ by matching color information in pixels of the image data in the image target region 106′ to predefined color parameters associated with color information of the user input device 103. The position of the user input device 103 and the related image coordinate (u′, v′) may thus be identified in the image target region 106′, by identifying color information in the image data that matches color information of the particular user input device 103.

The processing unit 104 may be configured to determine a location of the image target region 106′, 106″ in the image sensor coordinate system (u, v) from a perspective matrix calculation comprising determining a set of image sensor coordinates (u′, v′; u″, v″) associated with a corresponding set of surface coordinates (x′, y′, x″, y″) of a series of touch input. Determining the mentioned set of image sensor coordinates may comprise matching color information in pixels of the image data in the image sensor coordinate system (u, v) to predefined color parameters associated with color information of the user input device 103. The captured image data may thus be compared to defined color information of a user input device 103 providing touch input at a set of surface coordinates (x′, y′, x″, y″), for identifying the corresponding set of image sensor coordinates (u′, v′; u″, v″). A perspective matrix may be determined from the mentioned sets of associated coordinates. Subsequent touch input may be mapped by the perspective matrix to the image sensor coordinate system (u, v) as an image target region 106′, 106″, in which the user input device 103 is captured and subsequently identified. This allows for an effective correlation between the surface coordinates (x, y) and the image sensor coordinates (u, v). The perspective matrix may be determined at the setup of the touch sensitive apparatus 100, and/or it may be continuously updated and refined based on the continuous identification of the image sensor coordinates (u, v) of the user input device 103 during use.

The processing unit 104 may be configured to determine a size of the image target region 106′, 106″, in the image sensor coordinate system (u, v) based on a distance 107 from the imaging device 102 to a surface coordinate (x′, y′; x′, y″) of a touch input. FIGS. 2a-b illustrates an example where a user input device 103 provides touch input at two different surface coordinates (x′, y′) and (x″, y″), at two different distances from the imaging device 102 (i.e. the imaging plane thereof). For the second surface coordinate (x″, y″), positioned closer to the imaging device 102, an associated image target region 106″ is determined as having an increased size in the image sensor coordinate system (u, v), compared to the first surface sensor coordinate (x′, y′), due to the increased size of the corresponding image of the user input device 103 closer to the imaging device 102 (see also FIG. 3). The size of the image target region 106′, 106″, may thus be optimized depending on the position of the user input device 103 on the touch surface 101, allowing for facilitated identification of the image sensor coordinates (u′, v′; u″, v″) of the image data of the user input device 103.

Determining first and second image sensor coordinates (u′, v′; u″, v″) as described above should be construed as determining the image sensor coordinates of a portion of the captured image containing the image data of the user input device 103. Such portion may be represented by a varying amount of pixels in the image, e.g. due to the dependence on distance 107, or the size of the user input device 103. Once an image sensor coordinate (u, v) has been identified, e.g. in an image target region 106′, 106″, as comprising image data of the user input device 103, for example by matching color information thereof, it is not necessary to analyze further portions of the image (at other image sensor coordinates) unless the image data does not correspond sufficiently to the predetermined image parameters associated with the particular user input device 103. The image data may be analyzed by utilizing different averaging methods or other image processing techniques to provide reliable matching. The color information may thus be obtained by averaging several pixels within the image target region 106′, 106″. Pixel-by-pixel identification may also be used. The most prominent color may be utilized. A color distance measure may be used to find the similarity of colors to a known reference. Foreground estimation of the captured image data may be utilized to facilitate the identification. The image data may be analyzed by matching the color information to a predefined set of colors, such as red, green, blue. A default color value may be set, such as black, if the color in the image is not similar enough to the predefined color information. The predefined set of colors may be chosen to match the color characteristics of any filter components in the imaging device 102, for example Bayer filters with defined colors. In some embodiments, the color may be a ‘color’ in a non-visible part of the spectrum. E.g. The stylus may be configured to emit or reflect light in the infra-red portion of the spectrum (e.g. 850 nm, 940 nm, etc.) and a corresponding filter and image sensor are used to match this light wavelength. Use of wavelengths in the non-visible spectrum may provide advantages including improved ambient light noise and the option of actively illuminating the stylus with IR emitters from the connected touch sensor and/or from the image sensor.

The processing unit 104 may be configured to compensate the position of the image target region 106′, 106″, in the image sensor coordinate system (u, v) by determining motion characteristics, such as a speed and/or acceleration, of the user input device 103 when moving in a path along the surface coordinate system (x, y). It is thus possible to compensate which part in the image sensor coordinate system (u, v) to look at for finding image data of the user input device 103, e.g. if moving quickly or erratically over the touch surface 101. In case the imaging device 102 operates at a lower speed than the touch sensitive apparatus 100, the position of the image target region 106′, 106″, may be back-tracked, to compensate for any lag in the imaging device 102. This may be particularly beneficial for shorter distances between the user input device 103 and the imaging device 102. It is also possible to adjust the size of the image target region 106′, 106″, depending on the motion characteristics of the user input device 103. For example, the size of the image target region 106′, 106″, may be increased if the user input device 103 moves quickly any of the mentioned lag is detected. The size of the image target region 106′, 106″, may be adjusted depending on the sampling rate of the touch input. E.g. if the imaging device 102 captures images at a lower rate the size may be increased to compensate for the difference in timing.

The imaging device 102 may be configured to identify predetermined shapes of user input devices 103 in the image data. The identification may thus be facilitated, as other objects in the image data may be immediately discarded. The identification may be further improved by taking into account the distance 107 from the imaging device 102 to a surface coordinate (x′, y′; x′, y″) of a touch input. Thus, the imaging device 102 may be configured to identify sizes of said predetermined shapes by compensating for the distance 107.

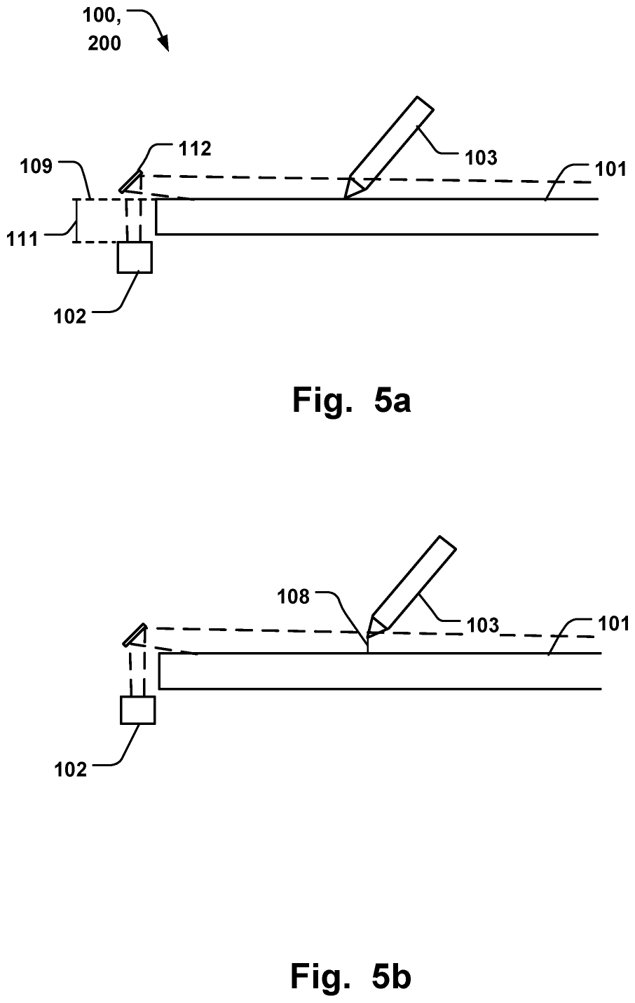

The imaging device 102 may be configured to capture the image data of the user input device 103 when located at a distance 108 from the touch surface 101, as schematically illustrated in FIG. 5b. For example, if the user input device 103 lifts from the touch surface 101 subsequent of a touch input at a surface coordinate (x, y), the imaging device 102 may be configured to track the motion of the user input device 103. This enables pre-triggering or quicker correlation between the touch input and the resulting image sensor coordinate (u, v). A faster identification process may thus be achieved, e.g. by positioning the image target region 106′, 106″, in the image sensor coordinate system (u, v) already before the user input device 103 touches the touch surface 101. The user input device 103 may be tracked so that the corresponding image sensor coordinate (u, v), at which image data of the user input device 103 may be captured, may be continuously updated also when the user input device 103 is at a distance 108 from the touch surface 101.

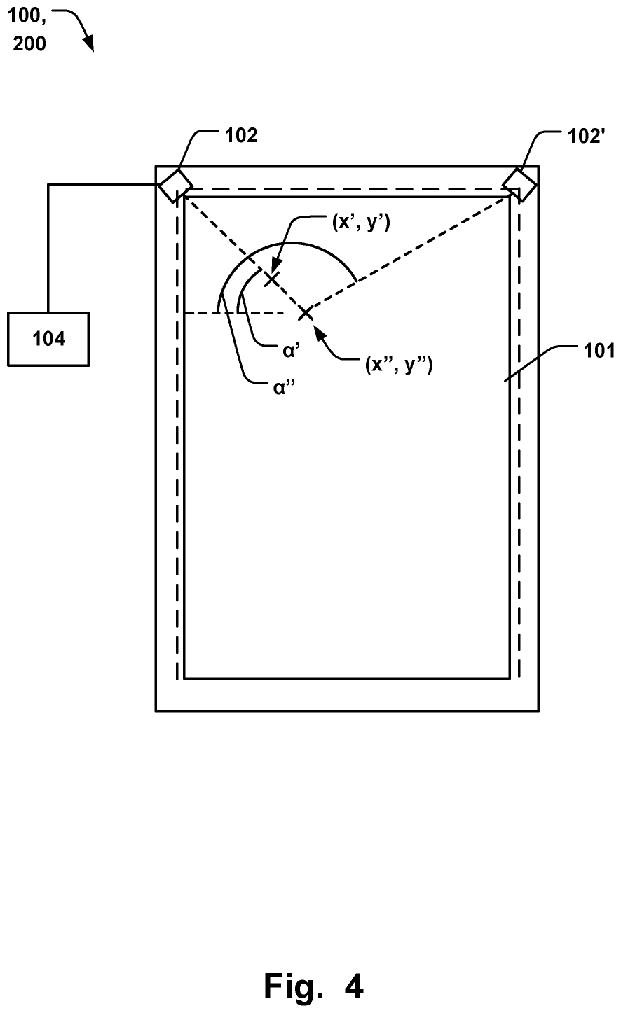

The imaging device 102 may be configured to capture the image data from two different angles (α′, α″) relative to the touch surface 101. FIG. 4 is a schematic illustration where touch input is provided at two different surface coordinates (x′, y′; x″, y″). Obtaining image data from two different angles (α′, α″) may be advantageous to avoid any occlusion issues, i.e. in case the touch input is provided simultaneously at the mentioned coordinates, so that a user input device 103 at surface coordinate (x′, y′) obscures a user input device positioned behind the latter, at the other surface coordinate (x″, y″), with respect to the imaging device 102 arranged at the angle α′ as illustrated. In such case the image obtained at angle α″ is not obscured and allows simultaneously identifying the user input device 103 at the surface coordinate (x″, y″). The touch sensitive apparatus 100 may thus comprise at least two imaging devices 102, 102′, arranged to capture the image data from two different angles (α′, α″) relative to the touch surface 101. It should be understood that a single imaging device 102 may be used, while providing for capturing image data at different angles (α′, α″), by utilizing e.g. different optical elements to direct the imaging path in different directions. Detecting the image data with (at least) two different imaging devices 102, 102′, also provides for reducing the maximum distance at which the image data needs to be captured, which may increase accuracy. Color information from several imaging devices 102, 102′, may also be combined to provide a more robust classification.

The processing unit 104 may be configured to correlate a plurality of simultaneous touch inputs, from a plurality of respective user input devices 103, at a set of surface coordinates (x′, y′; x″, y″) with a respective set of image sensor coordinates (u′, v′; u″, v″) at which image data of the user input devices 103 is captured by the imaging device 102. The processing unit 104 may be configured to generate touch output signals comprising a value configured to control visual output associated with the set of surface coordinates (x′, y′; x″, y″) based on the captured image data of the input devices 103 at the respective set of image sensor coordinates (x′, y′; x″, y″). It is thus possible to distinguish a plurality of different user input devices 103 in a reliable, simple, and robust identification process while providing for highly resolved positioning, as elucidated above.

The imaging device 102 may be arranged at least partly below a plane 109 in which the touch surface 101 extends. FIG. 5a is a schematic illustration showing an imaging device 102 at a distance 111 below the touch surface 101. This may provide for a more compact touch sensitive apparatus 100, since the imaging device 102 does not occupy space at the edge of the touch surface 101. A compact lens system 112 may direct the imaging path to the top of the touch surface.

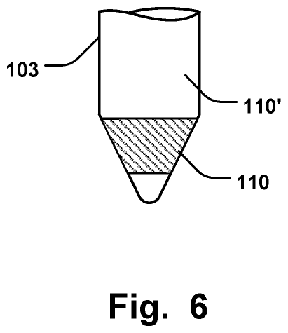

A touch system 200 is provided comprising a touch sensitive apparatus 100 as described above in relation to FIGS. 1-5, and a user input device 103. The user input device 103 may have a defined color as described above, and various parts of the user input device 103 may be colored as well as substantially the entire surface thereof, to optimize capturing the color information with the imaging device 102. It is also conceivable that the user input device 103 comprises more than one color, in different combinations, and that each combination, and the corresponding imaging data, is associated with a unique touch output signal comprising a value for controlling the response or interaction with the particular user input device 103. The user input device 103 may comprise a marker 110 having a predefined color parameter such as a predefined color balance. The predefined color balance may comprise a white balance gray card, such as a gray card reflecting 17-18% of the incoming light. It is thus possible to use the marker 110 as a color reference for identifying and classifying image data of the user input device 103 in the image sensor coordinate system (u, v). This may be particularly advantageous in case of using colors that are susceptible to image color shifts, which may be the case when capturing the images from longer distances, e.g. blue color appearing as gray. FIG. 6 shows a schematic illustration of (a part of) a user input device 103. The marker 110 is in this example arranged on a distal tip thereof, but may be arranged any part of the user input device 103. The part denoted 110′ may have a defined color as explained above, such as red, green, blue, etc. The marker 110 may also provide for facilitated identification in difficult lightning conditions, where the captured image data may be more prone to undesired color shifts, that may be due to light emitted from a display panel onto which the touch surface is placed. The marker 110 also provides for identifying a wider range of colors.

The user input device 103 may be a passive user input device 103. The touch sensitive apparatus 100 as described above in relation to FIGS. 1-6 is particularly advantageous in that it allows for distinguishing user input devices 103 based on the captured image data thereof. Active identification components of the user input device 103 are thus not necessary. It is conceivable however that the above described touch sensitive apparatus 100 utilizes active user input devices 103 for an identification procedure that combines active identification elements and methods to improve classification and customization of touch interaction even further. Both passive and active user input devices 103 may comprise the above described marker 110.

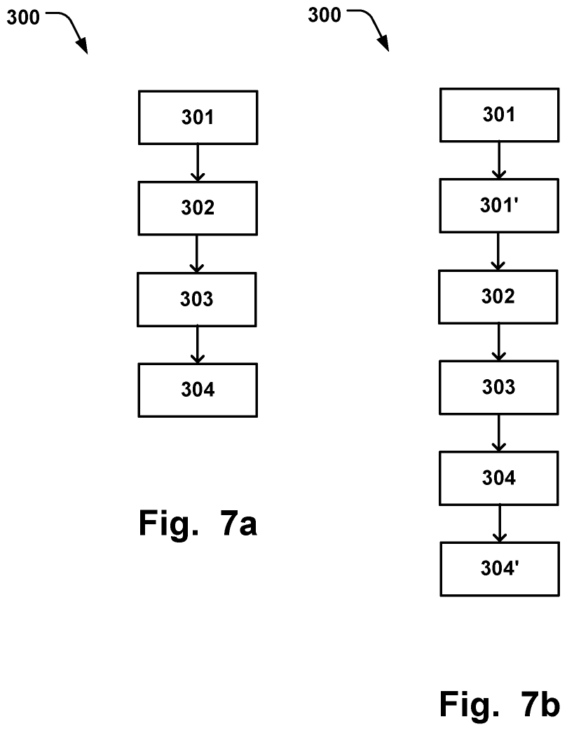

FIG. 7a illustrates a flow chart of a method 300 in a touch sensitive apparatus 100 having a touch surface 101 configured to receive touch input. The order in which the steps of the method 300 are described and illustrated should not be construed as limiting and it is conceivable that the steps can be performed in varying order. The method 300 comprises capturing 301 image data of a user input device 103 adapted to engage the touch surface 101 to provide said touch input, determining 302 a surface coordinate (x, y) of a touch input on the touch surface 101. The surface coordinate (x, y) may be determined from a position of an attenuation of light beams 105 emitted along the touch surface 101. The method 300 further comprises correlating 303 a touch input at a first surface coordinate (x′, y′) with a first image sensor coordinate (u′, v′) at which image data of the input device 103 is captured by the imaging device 102, and generating 304 a touch output signal based on the captured image data of the input device 103 at the first image sensor coordinate (u′, v′). The touch output signal comprises a value for controlling user input device interaction associated with the touch input at the first surface coordinate (x′, y′). The method 300 thus provides for the advantageous benefits as described above in relation to the touch sensitive apparatus 100 and FIGS. 1-6.

FIG. 7b illustrates a further flow chart of a method 300 in a touch sensitive apparatus 100. The order in which the steps of the method 300 are described and illustrated should not be construed as limiting and it is conceivable that the steps can be performed in varying order. The method 300 may comprise capturing 301′ image data comprising color information of the user input device 103, and generating 304′ a touch output signal comprising a value configured to control color of visual output associated with the first surface coordinate (x′, y′), wherein the color of the visual output is based on said color information.

A computer program product is also provided comprising instructions which, when the program is executed by a computer, cause the computer to carry out the steps of the method 300 as described above.

A touch input identification device 400 is also provided for a touch sensitive apparatus 100 having a touch surface 101 configured to receive touch input. The touch input identification device 400 comprises an imaging device 102 configured to be arranged on the touch sensitive apparatus 100 to have field of view looking generally along the touch surface 101. The imaging device 102 is configured to capture image data of a user input device 103 adapted to engage the touch surface 101 to provide touch input. The touch input identification device 400 comprises a processing unit 104 configured to retrieve a surface coordinate (x, y) of a touch input on the touch surface 101. The surface coordinate (x, y) may be determined from a position of an attenuation of light beams 105 emitted along the touch surface 101. The processing unit 104 is configured to correlate a touch input at a first surface coordinate (x′, y′) with a first image sensor coordinate (u′, v′) at which image data of the input device 103 is captured by the imaging device 102. The processing unit 104 is configured to generate a touch output signal based on the captured image data of the input device at the first image sensor coordinate (u′, v′), where the touch output signal comprises a value for controlling user input device interaction associated with the touch input at the first surface coordinate (x′, y′). The touch input identification device 400 may be retrofitted to an existing touch sensitive apparatus 100. The touch input identification device 400 thus provides for the advantageous benefits as described above in relation to the touch sensitive apparatus 100 and FIGS. 1-6.

The present invention has been described above with reference to specific examples. However, other examples than the above described are equally possible within the scope of the invention. The different features and steps of the invention may be combined in other combinations than those described. The scope of the invention is only limited by the appended patent claims.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

1. A touch sensitive apparatus comprising
a touch surface configured to receive touch input,
a touch sensor configured to determine a surface coordinate of a touch input on the touch surface,
an imaging device having a field of view looking generally along the touch surface, whereby the imaging device is configured to capture image data of a user input device adapted to engage the touch surface to provide said touch input,
a processing unit configured to
receive a first surface coordinate of a touch input from the touch sensor,
correlate the touch input at the first surface coordinate with a first image sensor coordinate at which image data of the input device is captured by the imaging device, and
generate a touch output signal based on the captured image data of the input device at the first image sensor coordinate,
wherein the touch output signal comprises a value for controlling user input device interaction associated with the touch input at the first surface coordinate.

2. Touch sensitive apparatus according to claim 1, wherein said value is used to control visual output associated with touch input at the first surface coordinate, whereby said visual output is based on the captured image data of the input device at the first image sensor coordinate.

3. Touch sensitive apparatus according to claim 2, wherein said visual output comprises a digital ink, applied by the user input device, and said value is configured to control the characteristics of the digital ink.

4. Touch sensitive apparatus according to claim 2, wherein the imaging device is configured to capture image data comprising color information of the user input device, and wherein the processing unit is configured to generate a touch output signal comprising a value configured to control color of the visual output based on said color information.

5. Touch sensitive apparatus according to claim 1, wherein the processing unit is configured to
determine an image target region, in an image sensor coordinate system of the imaging device, in which image data of the user input device is captured, and
determine a position of the first image sensor coordinate in said image target region by matching color information in pixels of the image data in the image target region to predefined color parameters associated with color information of the user input device.

6. Touch sensitive apparatus according to claim 5, wherein the processing unit is configured to determine a location of the image target region in the image sensor coordinate system from a perspective matrix calculation comprising determining a set of image sensor coordinates associated with a corresponding set of surface coordinates of a series of touch input, wherein determining the set of image sensor coordinates comprises matching color information in pixels of the image data in the image sensor coordinate system to predefined color parameters associated with color information of the user input device.

7. Touch sensitive apparatus according to claim 5, wherein the processing unit is configured to determine a size of the image target region in the image sensor coordinate system based on a distance from the imaging device to a surface coordinate of a touch input.

8. Touch sensitive apparatus according to claim 5, wherein the processing unit is configured to compensate the position of the image target region in the image sensor coordinate system by determining motion characteristics, such as a speed and/or acceleration, of the user input device when moving in a path along the surface coordinate system.

9. Touch sensitive apparatus according to claim 1, wherein the imaging device is configured to
identify predetermined shapes of user input devices in the image data, and
identify sizes of said predetermined shapes by compensating for a distance from the imaging device to a surface coordinate of a touch input.

10. Touch sensitive apparatus according to claim 1, wherein the imaging device is configured to capture said image data of the user input device when located at a distance from the touch surface.

11. Touch sensitive apparatus according to claim 1, wherein the imaging device is configured to capture said image data from two different angles relative to the touch surface, and/or wherein the touch sensitive apparatus comprises at least two imaging devices arranged to capture said image data from two different angles relative to the touch surface.

12. Touch sensitive apparatus according to claim 1, wherein the imaging device is arranged at least partly below a plane in which the touch surface extends.

13. Touch sensitive apparatus according to claim 1, wherein the processing unit is configured to correlate a plurality of simultaneous touch inputs, from a plurality of respective user input devices, at a set of surface coordinates with a respective set of image sensor coordinates at which image data of the user input devices is captured by the imaging device, and
generate touch output signals comprising a value used to control visual output associated with the set of surface coordinates, based on the captured image data of the input devices at the respective set of image sensor coordinates.

14. A touch system comprising a touch sensitive apparatus according to claim 1 and a user input device, wherein the user input device comprises a marker having a predefined color parameter such as a predefined color balance.

15. Touch system according to claim 14, wherein the user input device is a passive user input device.

16. A method in a touch sensitive apparatus having a touch surface configured to receive touch input, comprising
capturing image data of a user input device adapted to engage the touch surface to provide said touch input,
determining a surface coordinate of a touch input on the touch surface,
correlating a touch input at a first surface coordinate with a first image sensor coordinate at which image data of the input device is captured by the imaging device, and
generating a touch output signal based on the captured image data of the input device at the first image sensor coordinate,
wherein the touch output signal comprises a value for controlling user input device interaction associated with the touch input at the first surface coordinate.

17. Method according to claim 16, comprising
capturing image data comprising color information of the user input device, and
generating a touch output signal comprising a value configured to control color of visual output associated with the first surface coordinate, wherein the color of the visual output is based on said color information.

18. A computer program product comprising instructions which, when the program is executed by a computer, cause the computer to carry out the steps of the method according to claim 16.

19. A touch input identification device for a touch sensitive apparatus having a touch surface configured to receive touch input, comprising
an imaging device configured to be arranged on the touch sensitive apparatus to have field of view looking generally along the touch surface, whereby the imaging device is configured to capture image data of a user input device adapted to engage the touch surface to provide said touch input,
a processing unit configured to
retrieve a surface coordinate of a touch input on the touch surface,
correlate a touch input at a first surface coordinate with a first image sensor coordinate at which image data of the input device is captured by the imaging device, and
generate a touch output signal based on the captured image data of the input device at the first image sensor coordinate,
wherein the touch output signal comprises a value for controlling user input device interaction associated with the touch input at the first surface coordinate.
